(19) United States
(12) Patent Application Publication
(10) Pub. No.: US 2009/0323095 A1
(43) Pub. Date: Dec. 31, 2009

(54) IMAGE FORMING APPARATUS AND METHOD

(75) Inventors: Koji TANIMOTO, Shizuoka-ken (JP); Kunihiko Miura, Kanagawa-ku (JP); Hidekazu Sekizawa, Kanagawa-ken (JP); Jun Sakakibara, Tokyo (JP); Koji Kawai, Shizuoka-ken (JP); Hirokazu Shoda, Kanagawa-ken (JP); Naoyuki Misaka, Shizuoka-ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 12/164,712

(22) Filed: Jun. 30, 2008

(51) Int. Cl. G06F 3/12

(52) U.S. Cl. 358/1.13

(57) ABSTRACT

A method and apparatus of forming an image includes reading an original with a first resolution. An original is read with a second resolution which is different from said first resolution. The image information read with the first resolution and the second resolution is converted into image information of a third resolution for image forming. An image is formed with the third resolution based on the image information converted by the conversion.

### FIELD OF THE INVENTION

The present invention generally relates to a copying machine and method for copying original documents and a multifunctional peripheral (MFP).

### BACKGROUND OF THE INVENTION

In general, a copying machine or multifunctional peripheral (MFP) includes a scanner (a mechanical reading system) for reading an original and a printer (an image forming means or unit) for printing an image.

As for the copying machine and MFP which performs a monochrome copy of an original, a monochrome sensor (brightness sensor) is built in the scanner part, and the darkness and lightness (brightness) of the original is read.

The printer forms a monochrome image based on the darkness and lightness (brightness) information. Therefore, if the original is in multiple colors, the difference in each color cannot be read. For example, when a monochrome scanner scans an image in which characters are printed in different colors on a certain color ground, the colors of the ground and characters are not discriminated. Therefore, the characters will be copied without being discriminated on the image.

In order to solve the problem described above, it is necessary to read the original in color and to use the color information. However, compared with a monochrome sensor, the sensitivity of a color sensor is generally low, and thus its image reading speed is slower than the monochrome sensor. If a user wants to maintain the reading speed, a color sensor which has a larger light-receiving area than a monochrome sensor is required so as to improve the sensitivity of the sensor. However, the problem is that the scanner will necessarily become big and will become expensive.

On the other hand, as for a copying machine and MFP which copies an original in color, the color sensor is built in the scanner part and the color information of the original is read. The printer forms a color image based on this color information. However, since the sensitivity of the color sensor is generally low as mentioned above as compared with the monochrome sensor, the color sensor which is the same size as the monochrome sensor, can read the image only at a lower speed than the monochrome sensor. In giving priority to the speed, it is necessary to use a color sensor which has a larger light-receiving area than the monochrome sensor so as to improve the sensitivity of the sensor. This will cause a problem that makes the device larger in size and more costlier.

Thus, in a monochrome copying machine or monochrome MFP, even if an outputted image is monochrome, a copy reflecting the color information of the original is desired. In that case, decreasing the speed or increasing the cost is not desirable. On the other hand, color copiers and color MFPs, which are inexpensive and can copy at high speed are desired.

The present invention is designed to solve one or more of the aforementioned problems.

### SUMMARY OF THE INVENTION

One embodiment of the present invention is directed to a scanner (or mechanical reading system) for reading an image and a converting unit for converting the read image information by the scanner into image information for printing by a printer, and a printer (image forming means) for recording the image according to the image information converted by the converting means.

In the scanner (the reading mechanical system) in accordance with the first embodiment of the present invention, a CCD sensor composed of a brightness sensor (a first reading unit: B/W) and a color sensor (a second reading unit: RGB). Resolution of the brightness sensor (the first reading unit) is configured to higher than the resolution of the color sensor (the second reading unit). The brightness sensor has a sensitivity of light wavelength wider than the color sensor, and even if its resolution is high (light-receiving area is narrow), it has the sensitivity equivalent to the color sensor which has a low resolution (light-receiving area is large). Therefore, even if the resolution is different, the brightness and the color information can be read at the same time maintaining the balance of the sensitivity. The converting unit converts the image information by the brightness sensor and the color sensor for forming the image by a printer.

When the apparatus performs monochrome copying, the converting means is capable of converting the read image information into monochrome print information to which both the darkness (lightness) information and the color information are reflected using high-resolution shading (brightness) information of the brightness sensor and the color information of the color sensor.

When the apparatus performs color copying, the converting unit is capable of converting the read image information into a color print information which has the resolution equal to the one the brightness sensor has, by improving the resolution of the color information of the color sensor with the higher density (brightness) information of the brightness sensor.

The printer is capable of outputting the print information converted by the converting means converts as a MONOCHROME image, mono color image, and color image.

### BRIEF DESCRIPTION OF THE DRAWINGS

FIG. 1 is a frontal outline view of an image forming apparatus in consistent with the present invention.

FIG. 2 is a partial cut-way side-view of the image forming apparatus of FIG. 1.

FIG. 3 is a block diagram of an image sensor unit consistent with the present invention.

FIG. 4 is a block diagram of a resolution and color conversion system consistent with the present invention.

FIG. 5 is a graphical representation of a color resolution conversion process consistent with the present invention.

FIGS. 6A-6F are examples of pixel data according to the color resolution conversion process of FIG. 5.

FIGS. 7A-7E are graphical representation of a color conversion process consistent with the present invention.

FIG. 8 is a graphical representation of another color conversion process consistent with the present invention.

FIG. 9 is a graph showing the spectral sensitivity characteristics of a xenon light source.

FIG. 10A is a plan view of an image sensor (CCD) that may be utilized in at least one embodiment of the invention.

FIG. 10B is a view showing the arrangement of the light-receiving surface of the image sensor of FIG. 10A.

FIG. 11 is a graph showing the spectral sensitivity characteristic of the light source of the image sensor (CCD) that may be utilized in at least one embodiment of the invention.

FIG. 12 is an explanatory drawing of a laser unit (exposure device) that may be utilized in at least one embodiment of the invention.

FIG. 13 is a timing chart showing a relationship among a photoconductive drum, an HSYNC sensor, and motion of a beam, and also a relation of each signal output, in accordance with at least one embodiment of the invention.

FIG. 14 shows one implementation of an operation panel (operation element) that may be utilized in at least one embodiment of the invention.

### DETAILED DESCRIPTION OF THE PREFERRED EMBODIMENTS

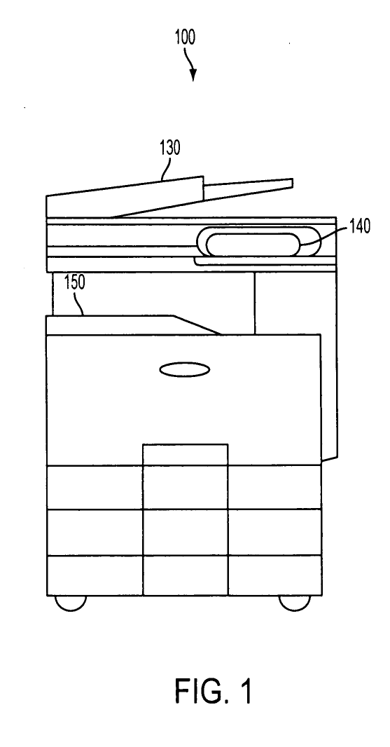

Referring now to FIG. 1, there is shown a frontal outline view of an image forming apparatus 100 consistent with the present invention. The image forming apparatus 100 may be, for example, a copier, fax, printer or multi-function peripheral (MFP). The image forming apparatus 100 may form the image on such media as paper or overhead transparencies.

The image forming apparatus 100 has an input feeder 130, an operation element 140 and an output tray 150. The input feeder 130, the operation element 140 and the output tray 150 may be configured as those known in the art.

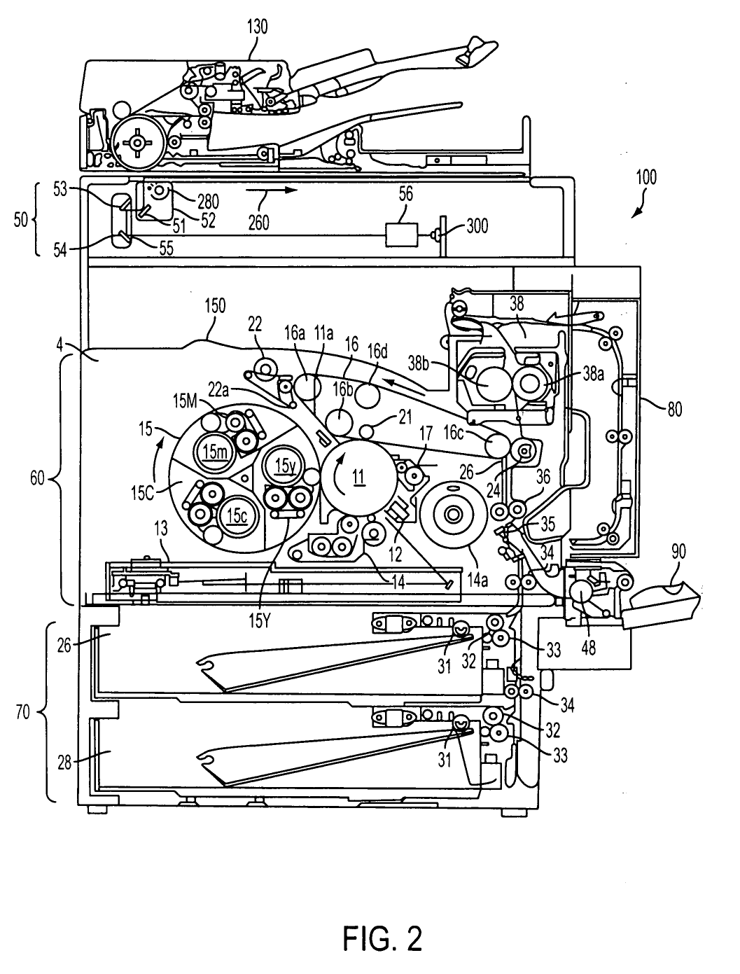

FIG. 2 is a partial cut-away side-view of the image forming apparatus 100. The image forming apparatus 100 includes a mechanical reading system (or scanner) 50, printer 60, and a paper feed unit 70. A duplex unit 80 and a manual feed unit 90 are removable attached to the right side of the image forming apparatus 100. The duplex unit 80 reverses a paper P on which an image was formed on one side by the printer, and supplies the paper P again to the printer, so that the duplex print on the paper P is enabled. The manual feed unit 90 is for supplying paper manually to the printer.

The following is an explanation of the operation of the reading mechanical system 50. An original read by the reading mechanical system (or scanner) 50 is transported by an input feeder 130, and moves over an original glass 220 at a constant speed or is placed onto the original glass 220 with its back side up. A light source 280 built in the reading mechanical system 50 irradiates the original, and the reflected light from the original is directed to the image sensor unit 300 via mirrors 51, 53, and 54 and lens 56.

The light source 280 and the mirror 51 compose a first carriage 52, and the mirrors 53 and 54 compose a second carriage 55. When the original is transported by the input feeder 130, the first carriage 52 and the second carriage 55 do not move. That is, the light irradiated from the light source 280 does not move, but the original moves in the sub scanning direction 260 and the irradiated light is scanned in the sub scanning direction and the reflected light is directed to the image sensor unit 300.

When the original is placed on the original glass 220, the first carriage 52 and the second carriage 55 are moved from the left to the right (in the sub scanning direction 260) by a driving motor (not shown), and the irradiated light from the light source 280 is scanned (in the sub scanning direction). Then, the reflected light from the original is directed from the image sensor unit 300.

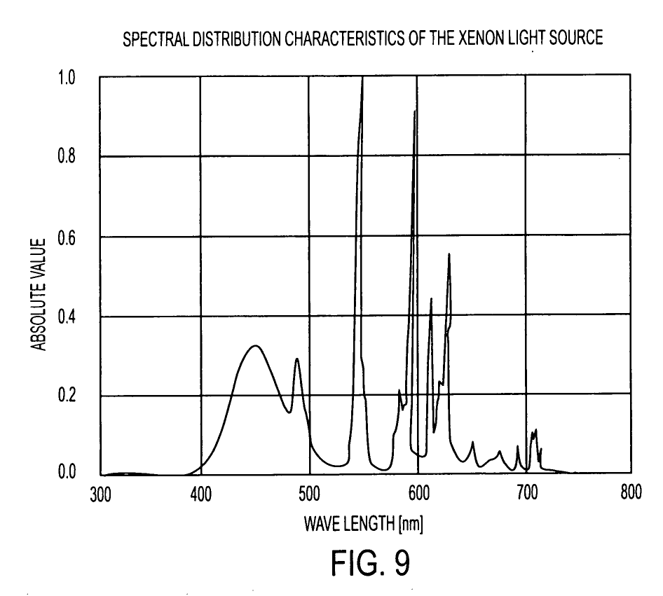

FIG. 9 is a spectral-distribution chart of the xenon lamp (white lamp) of the light source 280. As shown in FIG. 9, the light irradiated from the xenon lamp (white lamp) of the light source 280 contains the light of the wavelength from about 400 nm to 730 nm in order to read a color copy.

The image sensor unit 300 can be configured to generate color signals and monochrome signals and output them on color channels and monochrome channels. The image sensor unit 300 can be a 4-line CCD or it can include a CCD sensor and other arrays of photodiodes.

The color signals can be formed in one channel for each color such as each of the three primary colors R, G, and B. The monochrome signal may be formed in one monochrome channel or a pair of monochrome channels. The color signals and the monochrome signal (or signals) may be output simultaneously, such as in parallel, or they may be switched. The image sensor unit can be configured as one or more integrated circuit chips. The image sensor unit can also include or be used in conjunction with color filters arranged with respect to the CCDs for each color.

As used herein, a “charge-coupled device” or “CCD” is a light sensitive integrated circuit that produces and stores (generally temporarily) electric charges representing light levels to which the CCD is exposed.

A CCD may be formed of an array of photodiodes to thereby provide a representation of an image to which the CCD is exposed. The array may be one- or multi-dimensional. A “photodiode” is a semiconductor diode that generates an electric signal when exposed to light. The photodiodes of a CCD may have particular sensitivities, such as for particular light frequencies or levels.

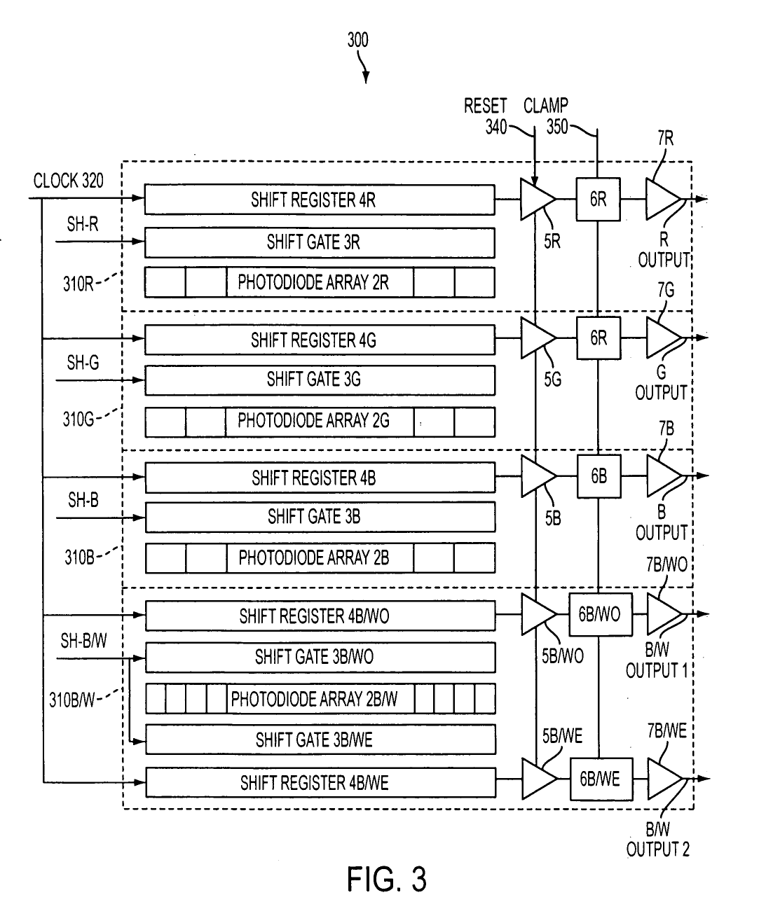

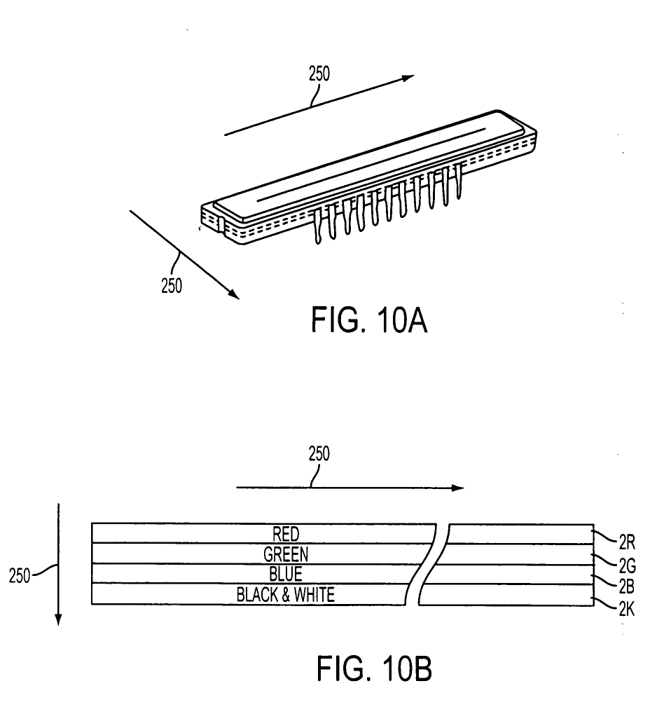

Referring now to FIG. 3, there is shown a block diagram of an image sensor unit 300. The image sensor unit 300 may be used as the image sensor unit for the reading mechanical system 50 of FIG. 2. The image sensor unit 300 is a 4-line type, and includes three photoelectric converters 310R, 310G, 310B for color and one photoelectric converter 310B/W for monochrome. The letters R, G, B, and B/W refer to the respective color: red, green, blue, and monochrome (black/white). FIG. 10A is an outline view of the image sensor unit 300. FIG. 10B is an enlarged view of the light-receiving part.

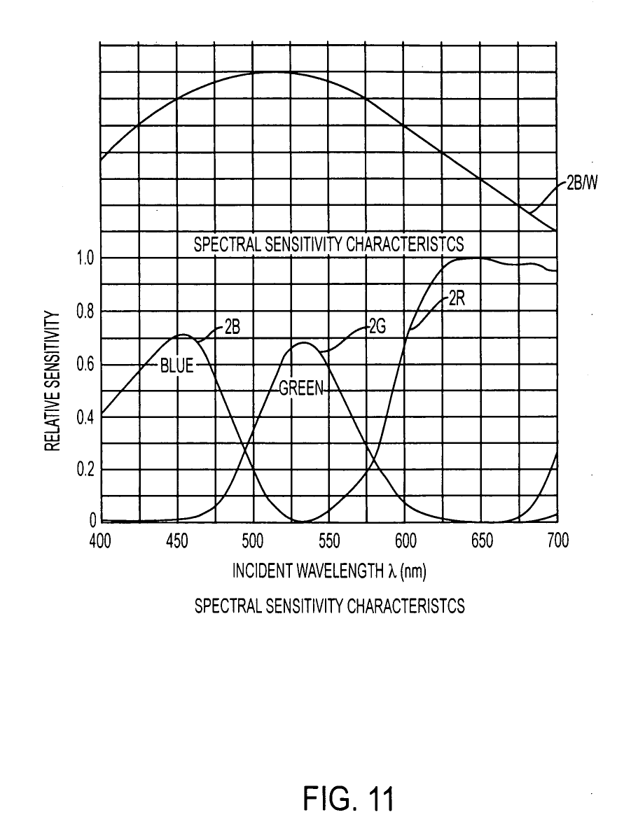

The photoelectric converters 31 OR, 310G, 310B, 310B/W each have a single linear (one-dimensional) photodiode array 2R, 2G, 2B, 2B/W, comprising a number of photodiodes. Each photodiode of the photodiode arrays 2R, 2G, 2B, 2B/W has a sequential reference number from some arbitrary starting point in the respective array. Accordingly, based upon its reference number, a photodiode may be referred to as “odd” or “even.” The photodiodes of the photodiode arrays 2R, 2G, 2B, 2B/W may be arranged in the main scanning direction 250. The photodiodes store (photoelectrically convert) charges according to a received quantity of light. The photodiodes may be adapted to be sensitive to predetermined frequencies. The sensitivity characteristics of 2R, 2G, 2B, and 2B/W are shown in FIG. 11. As is clear from the drawing, the line sensors 2R, 2G, and 2B respectively have sensitivity only in a specific-region waveform. On the contrary, the line sensor 2B/W has sensitivity from less than 400 nm to over 700 nm.

The photodiode arrays 2R, 2G, 2B, 2B/W may be rectilinear, have a uniform length and width, and be aligned in the main scanning direction. The order of the four kinds of photodiode arrays 2R, 2G, 2B, 2B/W in the sub-scanning direction is optional. However, to obtain better balance of the three color outputs (R Output, G Output, B Output), it is preferable for the monochrome photodiode array 2B/W to be positioned at an end (on the uppermost part or lowermost part shown in FIG. 3) of the photodiode arrays 2R, 2G, 2B instead of between them. FIG. 3 shows a case that the monochrome photodiode array 2B/W is in the lowermost position.

The photodiode arrays 2R, 2G, 2B, 2B/W may be spaced at respective intervals and disposed in positions relative to one another as shown. In the sub-scanning direction, the intervals between the center lines of the photodiode arrays 2R, 2G, 2B, 2B/W may be an integral multiple of the reading pitch. The reading pitch may be determined by the product of the moving speed of a carriage of a scanner or the moving speed of an original by the input feeder 130 by the ADF 199 in the mechanical reading system 50 (FIG. 2) and the period of time of SH-R, SH-G, SH-B, and SH-B/W.

As shown in FIG. 3, the photodiode arrays 2R, 2G, 2B, 2B/W include a number of photodiodes (i.e., each box in each array), where each photodiode corresponds to a pixel. Although the figure may appear to show each of the photodiode arrays 2R, 2G, 2B, 2B/W having a large central portion, this is intended to represent an undefined number of photodiodes. The photodiodes have respective light receiving surfaces. The light receiving surfaces of the photodiodes may have a uniform height and width. The size and shape of the light receiving area may be one determinant of a photodiode's sensitivity. The area of the color and monochrome photodiodes may be the same. It is also possible for the color photodiodes to be larger than the monochrome photodiodes.

In the embodiment as shown in FIG. 3, all of the photodiodes of the photodiode arrays 2R, 2G, 2B are the same size, but are twice the size of the photodiodes of the photodiode array 2B/W. Accordingly, the photodiode array 2B/W has twice as many photodiodes as the photodiode arrays 2R, 2G, 2B, whereby each array has the same number of photodiodes. Because of the relative sizes of the area of the photodiodes and because of the timing of the output signals, the combined resolution of the monochrome output signals B/W Output 1 and B/W Output 2 is twice the resolution of the color output signals R Output, G Output, B Output in the main scanning direction, but the same resolution in the sub-scanning direction.

In FIG. 3, the color photoelectric converters 310R, 310G, 310B respectively have shift gates 3R, 3G, 3B, shift registers 4R, 4G, 4B, reset gates 5R, 5G, 5B, clamp circuits 6R, 6G, 6B, and amplifiers 7R, 7G, 7B. The monochrome photoelectric converter 310B/W has shift gates 3B/WO, 3B/WE (where O means odd and E means even), shift registers 4B/WO, 4B/WE, reset gates 5B/WO, 5B/WE, clamp circuits 6B/WO, 6B/WE, and amplifiers 7B/WO, 7B/WE.

The stored charges of the photodiode arrays 2R, 2G, 2B, are shifted to the corresponding shift registers 4R, 4G, 4B via the shift gates 3R, 3G, 3B which are put into open state according to shift signals SH-R, SH-G, SH-B. The stored charges of the odd pixels of the photodiode array 2B/W are shifted to the corresponding shift register 4B/WO via the shift gate 3B/WO, which is put into an open state according to shift signal SH-B/W. Similarly, the stored charges of the even pixels of the photodiode array 2B/W are shifted to the corresponding shift register 4B/WE via the shift gate 3B/WE, which is put into an open state according to shift signal SH-B/N. The shift signals SH-R, SH-G, and SH-B may be the same. The shift signal SH-B/W may have a cycle which is equal to one half of the cycle of the shift signals SH-R, SH-G, SH-B. Thus, by making the cycle of SH-B/W signals twice the cycle of the other SH signals, the monochrome read resolution can be twice the resolution of the color's. The shift registers 4R, 4G, 4B, 4B/WO, 4B/WE may be CCD analog shift registers.

To the respective shift registers 4R, 4G, 4B, 4B/WO, 4B/WE, the stored charges of the photodiodes arrays 2R, 2G, 2B, 2B/W are shifted according to a predetermined timing. The respective shift registers 4R, 4G, 4B, 4B/WO, 4B/WE may output the shifted stored charges at respective serial signals (a one-dimensional image signal) according to a single clock signal 320. In this case, in order to prevent the output signals from interfering, a reset signal 340 may be provided via the reset gates 5R, 5G, 5B, 5B/WO, 5B/WE. Thereafter, the output signals are clamped by the clamp circuits 6R, 6G, 6B, 6B/WO, 6B/WE in response to a clamp signal 350 and amplified and outputted by the corresponding amplifiers 7R, 7G, 7B, 7B/WO, 7B/WE.

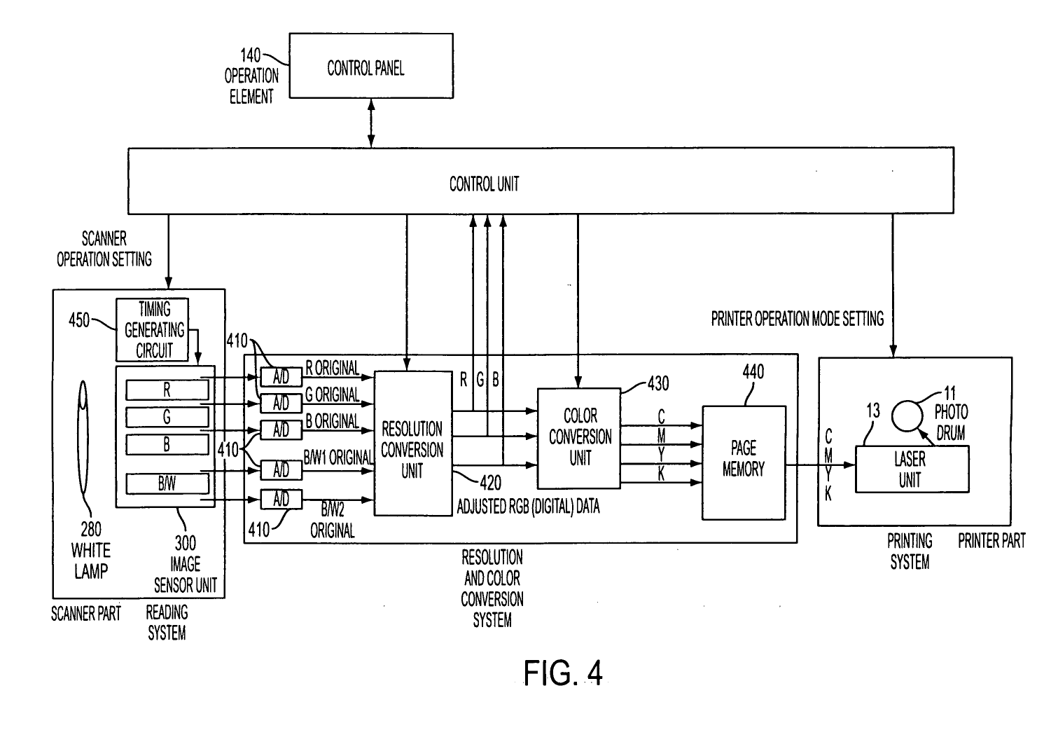

In operation, in response to a command or instruction to read an original in color mode, a control unit is configured to turn on the white lamp 280 to illuminate the original. The light reflected from the original is detected by the image sensor unit 300. A timing generating circuit 450 (FIG. 4.) provides the shift command signals SH-R, SH-G, SH-B, SH-B/W, the clock signal 320, the reset signal 340, and the clamp signal 350 as shown in FIG. 3. In the image sensor unit 300, the electric charge accumulated in the photodiode arrays 2R, 2G and 2B for the three primary colors R, G and B by photoelectric conversion is transferred to shift registers 4R, 4G and 4B through the shift gates 3R, 3G and 3B according to shift command signals SH-R, SH-G and SH-B, and serially outputted from the shift registers 4R, 4G and 4B while the photodiode arrays 2R, 2G, 2B are charging electricity for the next photoelectric conversion according to the clock signal 320. Then, it is provided sequentially through the reset gates 5R, 5G and 5B, the clamping circuits 6R, 6G and 6B, and the amplifiers 7R, 7G and 7B.

Similarly, the electric charge accumulated by photoelectric conversion in the odd and even pixels of the photodiode array 2B/W for the monochrome data is respectively transferred to the shift registers 4B/WO, 4B/WE, through the shift gates 3B/WO, 3B/WE, according to the shift command signal SH-B/W, and serially outputted from the shift registers 4B/WO, 4B/WE while the photodiode array 2B/W is charging electricity for the next photoelectric conversion according to the clock signal 320. Then, it is respectively provided sequentially through the reset gates 5B/WO, 5B/WE, the clamping circuits 6B/WO, 6B/WE, and the amplifiers 7B/WO, 7B/WE.

The five image data streams output from the image sensor unit 300 of FIG. 3 include R Output, G Output, B Output, B/W Output 1, and B/W Output 2. In a preferred embodiment, the resolution of the RGB Output data is 300 dpi (=second resolution), whereas the output of the B/W Output data (i.e., the combination of B/W Output 1 and B/W Output 2) is 600 dpi (=first resolution). The image data streams are provided to a resolution and color conversion system that adjusts the resolution of the color data and converts the image data to the CMYK color space.

As stated above, the light-receiving part of the 4-line CCD sensor 300 is composed of a line sensor B/W which does not arrange the light filter as the first reading means (or unit), a line sensor R which has arranged the light filter for giving a sensitivity to the red as the second reading means (or unit), a line sensor G which has arranged the light filter for giving a sensitivity to green, and a line sensor B which has arranged the light filter for giving a sensitivity to blue.

Considering the combination with the light source 280 which irradiates lights containing the wavelength from about 400 nm to 730 nm for reading a color image, sensitivity is balanced by making the area of the light-receiving part of the second reading means, the line sensor R, line sensor G, and line sensor B greater than the area of the light-receiving part of the line sensor K.

Specifically, as for the line sensor K which is the first reading means, 7500 photodiode arrays are arranged in a 4.7-micrometer pitch in the effective pixel region. As for the line sensor R, line sensor G, and line sensor B which are the second reading means, 3750 photodiode arrays are arranged in a 9.4-micrometer pitch in the effective pixel region.

The pitch of 4.7 micrometers of the photodiode of the 4-line sensor 117 is equivalent to the pitch of 42.3 micrometers (=600 dpi: the first resolution) on the original surface, and the pitch 9.4 micrometer of the photodiode is equivalent to 84.6 micrometers (=300 dpi: the second resolution) on the original surface.

A resolution and color conversion system in accordance with an embodiment of the present invention will now be described in detail. FIG. 4 is a block diagram showing operations and signals utilized in at least one embodiment of the present invention. As shown in FIG. 4, the resolution and color conversion system includes a plurality of A/D converters 410, a resolution conversion unit 420, a color conversion unit 430, and a page memory 440. The A/D converters 410 receive a respective one of the image data streams output from the image sensor unit 300. The A/D converters 410 convert R Output, G Output, B Output, B/W Output 1, and B/W Output 2 into digital image data R Original, G Original, B Original, B/W1 Original, and B/W2 Original, respectively, and provide the digital image data to the resolution conversion unit 420.

The relation between the density and data is explained briefly as follows. When copy density is high, the reflected light from an original is weak. When the reflected light is weak, the photodiode output of a CCD sensor is small. If the photodiode output is small, the value of digital image data which is outputted by the A/D converter 410 will be small.

Therefore, digital image data corresponding to an image with high (dark) copy density becomes a small value, and digital image data corresponding to an image with thin (bright) copy density becomes a big value. The digital data which A/D converter 410 outputs is 8 bits, and the range of the value is 0-255.

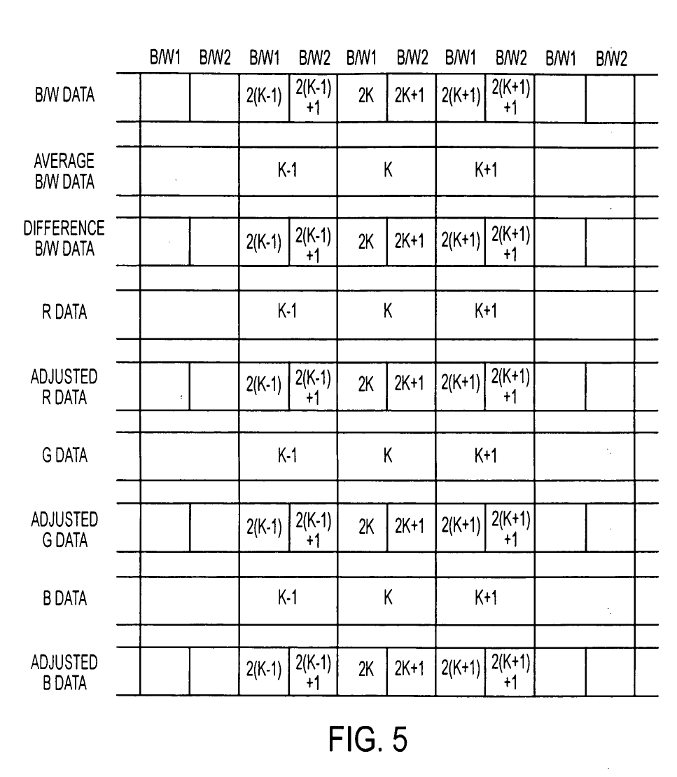

The resolution conversion unit 420 is configured to adjust the resolution of the color (digital) image data to match the resolution of the B/W (digital) image data. To make the resolution conversion, the resolution conversion unit 420 is preferably configured to use the B/W (digital) image data to adjust color (digital) image data and increase the resolution of the color (digital) image data. FIG. 5 illustrates a graphical representation of a color resolution conversion process that can be implemented in the resolution conversion unit 420.

As shown in FIG. 5, the first row corresponds to a portion of the B/W (digital) image data, which comprises the combination of the B/W Original 1 (B/W1) and B/W Original 2 (B/W2). Each box in the row represents an individual pixel of the B/W (digital) image data. The values in the boxes identify a particular pixel in the B/W (digital) image data, where K is an integer value greater than 0. For example, if K is 100, then pixel 2K corresponds to the 200th pixel in the B/W (digital) image data.

The B/W (digital) image data is used to generate Average B/W (digital) data, which is shown in the second row of FIG. 5. To generate the Average B/W (digital) data, the pixel densities (i.e., the B/W density between 0 and 255, of a pixel in the B/W (digital) image data) of each successive pair of pixels in the B/W (digital) image data is averaged together to generate a corresponding pixel of the Average B/W (digital) data. For example, the densities of pixels 2K and 2K+1 of the B/W (digital) image data are averaged together, and the average density becomes the density for pixel K of the Average B/W (digital) data. Each successive pair of pixels in the B/W (digital) image data that are averaged together includes one pixel from B/W Output 1 and one pixel from B/W Output 2. The pixel densities can be, for example, between 0 (darkest) and 255 (lightest).

The combination of the B/W (digital) image data and the Average B/W (digital) data is used to generate the Difference B/W (digital) data, which is shown in the third row of FIG. 5. To generate the Difference B/W (digital) data, the difference is calculated between the density of each pixel of the B/W (digital) image data and the density of the corresponding averaged pixel of the Average B/W (digital) data. For example, the value assigned to the 2K pixel of the difference B/W (digital) data is set to the difference between the density of pixel 2K of the B/W (digital) image data and the density of pixel K of the Average B/W (digital) data. Similarly, the value assigned to the 2K+1 pixel of the difference B/W (digital) data is set to the difference between the density of pixel 2K+1 of the B/W (digital) image data and the density of pixel K of the Average B/W data. If the respective densities of a successive pair of pixels in the B/W (digital) image data are different, then the value of the pixel of the Difference B/W (digital) data that corresponds to the pixel of the B/W (digital) image data with the higher density will have a negative value. Conversely, the value of the pixel of the Difference B/W (digital) data that corresponds to the pixel of the B/W (digital) image data with the lower density will have a positive value.

The Difference B/W (digital) data are used as adjustment factors to adjust the resolution of the color (digital) image data. More specifically, to adjust the resolution of the color (digital) image data, each pixel of the color (digital) image data becomes two pixels by adjusting the density of the pixel with the values of two corresponding pixels of the Difference B/W (digital) data. For example, the 2K pixel of the Adjusted R data is determined by adding the value of the 2K pixel of the Difference B/W (digital) data to the density of the K pixel of the R Original data, and the 2K+1 pixel of the Adjusted R data is determined by adding the value of the 2K+1 pixel of the Difference B/W (digital) data to the density of the K pixel of the R Original data.

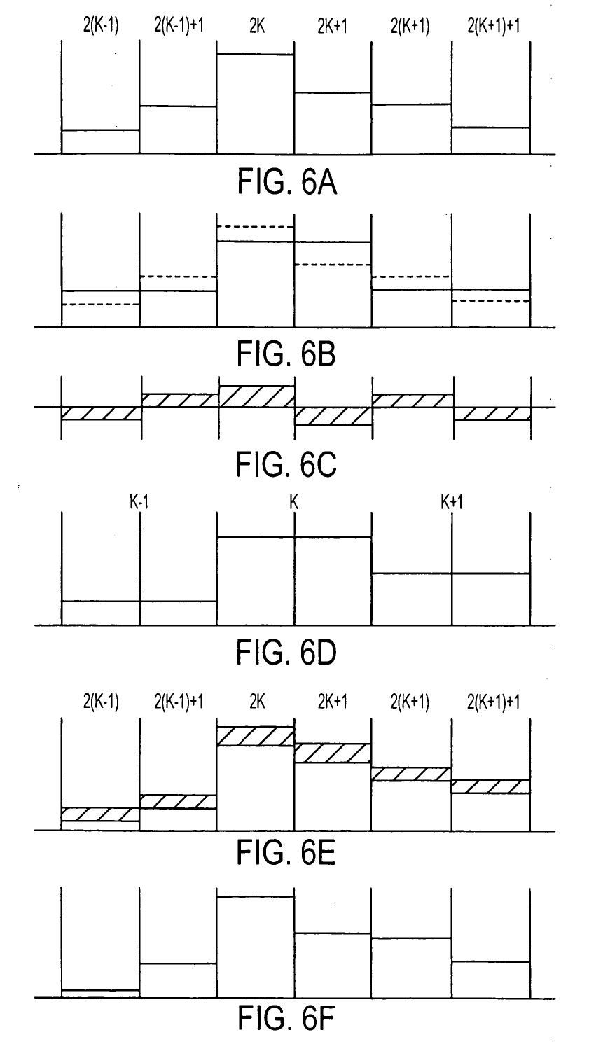

FIGS. 6A-6F are examples of pixel data according to the color resolution conversion process of FIG. 5. FIG. 6A shows a graphical representation of densities for a portion of pixels of the B/W (digital) image data. In FIGS. 6A-6F, the horizontal lines represent the density level of corresponding pixels. For example, in FIG. 6A, the density of pixel 2K is lower or smaller than the density of pixel 2K+1.

FIG. 6B shows a graphical representation of the Average B/W (digital) data. In FIG. 6B, the three solid horizontal lines correspond to the densities of three pixels of the Average B/W (digital) data derived from the densities of the respective six pixels of the B/W (digital) image data shown in FIG. 6A, which are shown as six horizontal dashed lines in FIG. 6B. As can be seen in FIG. 6B, the dashed line for pixel 2K is higher than the corresponding pixel of the average B/W (digital) data, whereas the dashed line for pixel 2K+1 is lower than the corresponding pixel of the Average B/W (digital) data. This positioning relative to the corresponding pixel of the Average B/W (digital) data is consistent with the relative densities of the pixel 2K and the pixel 2K+1 of the B/W (digital) image data.

FIG. 6C shows a graphical representation of the Difference B/W (digital) data. The slanted hashing for each pixel represents the difference between the density of a pixel of the B/W (digital) image data and the density of the corresponding pixel of the Average B/W (digital) data. If the slanted hashing is above the solid line, it represents a positive value (i.e., the density of a pixel of the B/W (digital) image data is less than the density of the corresponding pixel of the Average B/W (digital) data), and if the slanted hashing is below the line, it represents a negative value (i.e., the density of a pixel of the B/W image data is greater than the density of the corresponding pixel of the Average B/W data). For example, the slanted hashing corresponding to pixel 2K of the Difference B/W (digital) data is above the line, and the slanted hashing corresponding to pixel 2K+1 of the Difference B/W (digital) data is below the line.

As described above, the value of each pixel of the Difference B/W (digital) data represents an adjustment factor used to adjust the resolution of the color (digital) image data. FIGS. 6D-6F show a graphical representation of how the adjustment factors from FIG. 6C are used to adjust the resolution of the R Original data. FIG. 6D shows a graphical representation of densities for a portion of pixels of the R Original data. Since the R Original data has only one half the resolution of the B/W (digital) image data, there are only three pixels shown, pixels K−1, K, and K+1.

FIG. 6E shows a graphical representation of adding the adjustment factors corresponding to the Difference B/W (digital) data of FIG. 6C to the densities of the pixels of the R Original data of FIG. 6D. In this case, the slanted hashing representing the adjustment factor is positioned above or below the horizontal line representing the density of the pixel of the R Original data depending upon whether the adjustment factor is positive or negative. For example, the adjustment factor for pixel 2K is positive and is therefore positioned above the horizontal line representing the density of the pixel K of the R Original data.

FIG. 6F shows a graphical representation of the adjusted R (digital) data. As shown in FIG. 6F, the density for each pixel of the R Original data is increased or decreased in accordance with the adjustment factor. For example, a first pixel is obtained by decreasing the density of pixel K of the R Original data by the adjustment factor corresponding to pixel 2K of the Difference B/W (digital) data to generate the pixel 2K of the adjusted R (digital) data. Similarly, a second pixel is obtained by increasing the density of pixel K of the R Original data by the adjustment factor corresponding to pixel 2K+1 of the Difference B/W (digital) data to generate the pixel 2K+1 of the adjusted R (digital) data.

In this manner, the resolution conversion process can use the B/W (digital) image data to adjust the resolution of the color (digital) image data. The B/W (digital) image data has the resolution to which the color image data is being converted, such as from 300 dpi to 600 dpi. In the case where the B/W (digital) image data has twice the resolution of the color (digital) image data, each pixel of the color (digital) image data is used to generate two pixels of the adjusted color (digital) image data based on the adjustment factors derived from the B/W (digital) image data. As described above, the adjustment factors are generated according to a difference between a density of a pixel of the B/W (digital) image data and an average density of a corresponding pair of pixels. It should be understood, however, that using averages of a pair of pixels is merely exemplary. More than two pixels can be used to generate the average, and pixels for generating the average can be from a 2-dimensional arrangement or a linear arrangement of pixels. Further, by using the B/W (digital) image data, it is possible to convert the color (digital) image data to a higher resolution, while at the same time more accurately representing the colors of the original image at that higher resolution.

A method to increase and decrease the adjustment factors to the original data is explained below as a representative example. By applying this method, the adjustment factors are multiplied by a predetermined coefficient according to the balance of R, G, and B. And by using the result, the original data can be converted. For example, when the original data is R>G>B, it is also possible to adjust addition and reduction condition by the adjustment factors in the order of R>G>B.

Thus, the resolution conversion unit 420 improves the resolution of R, G, of the second resolution (300 dpi) to the third resolution (600 dpi), using the B/W information of the first resolution (600 dpi), so that the improvement in a color reading rate, downsizing of the device, and cost reduction are realized.

Returning to FIG. 4, after converting the resolution of the color (digital) image data, the resolution conversion unit 420 outputs RGB data (=adjusted RGB (digital) data) to the color conversion unit 430. The RGB data can also be provide to control unit 460 to perform other image processing functions on the RGB data. The color conversion unit 430 receives the RGB data and converts the RGB to the CMYK color space. The conversion from the RGB color space to the CMYK color space can be performed with standard conversions according to predetermined equations with predetermined coefficients, which processing is understood in the art. Alternatively, the process described below could be used.

In some cases, even though the original image is color and scanned by a color CCD, the user may request a copy be made in black and white. If so, the K data derived from the conventional conversion from RGB to CMYK data (i.e., not one involving the conversion illustrated by FIGS. 6A-6F) may result in a muddled image that does not accurately portray the color differences. For example, different shades of the same color may result in a black and white image that does not distinguish between the different shades. Accordingly, it would be desirable to have K data for generating a black and white copy that more accurately portrays the color differences of the original image.

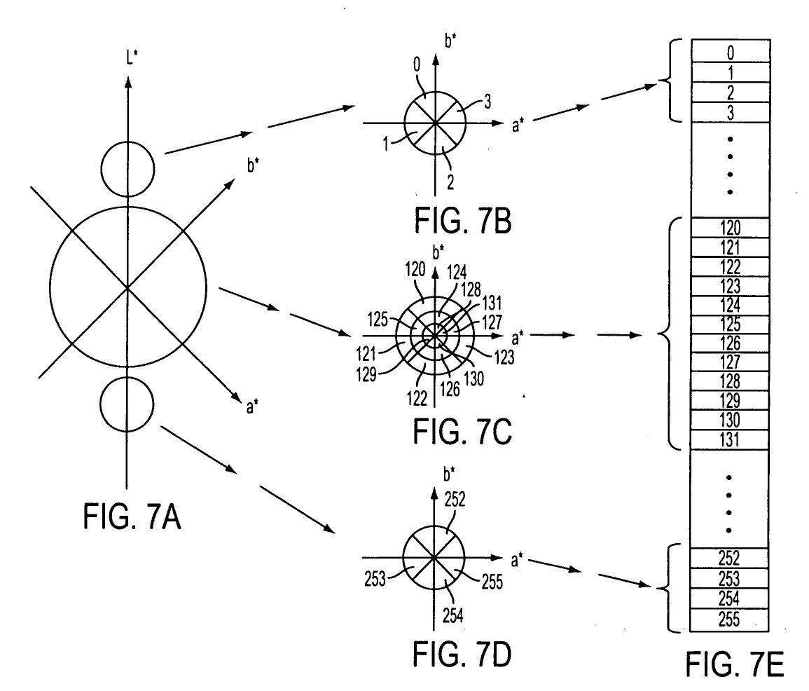

The color conversion unit 430 can be configured to perform a standard conversion between RGB data and CMYK data. The color conversion unit 430 can also be configured to perform a modified conversion between RGB data and CMYK data. The modified conversion can be performed for all RGB data or in response to certain commands or instructions. For example, if the original image is color, and a copy request is made for a black and white copy, then the modified conversion as illustrated in FIGS. 7A-7E is performed.

FIGS. 7A-7E are graphical representation of a color conversion process according to the color conversion unit 430 of FIG. 4. This color conversion process is a modified conversion process that can be referred to as a color difference process. The color difference process uses the RGB data to determine the K data for the CMYK color space. FIG. 7A shows the *a*b* color space. The *a*b* color space is representative of a brightness or luminescence level of a pixel and is a device independent color space. The L*a*b* space is a well known, uniform color space which the CIE (Commission International de l'Eclairage: INTERNATIONAL COMMISSION ON ILLUMINATION) established in 1976.

In L*a*b* space, L* is a value that represents luminance. L* has a value range of 0 to 100, and the more a value is large, the more a luminance increases. The value a* expresses that red is denser when the value is greater to the plus direction, and green is denser when the value is greater to the minus direction. The value b* expresses that yellow is denser when the value is greater to the plus direction, and blue is denser when the value is greater in the minus direction.

When the value of a* and b* is 0, it expresses the achromatic color without color. a* and b* have the range value of about −80-+80. In general the L*a*b* color space can be viewed as approximating a three dimensional oval shape arranged along the three axes L*, a*, and b*. Each location in the oval shape represents a different brightness or luminescence level. As shown in FIG. 7A, three portions of the L*a*b* color space are shown.

The RGB data received by the color conversion unit 430 can map the RGB data into a corresponding L*a*b value. This mapping of RGB data into L*a*b* data is a conventional process known to one skilled in the art.

The actual mapping can be device dependent and preferably takes into account certain properties about the elements of the scanning unit used to generate the RGB data and other scanning parameters such as CCD sensitivity and resolution. To make the mapping, it may be possible to use lookup tables (LUTs) using the RGB data as inputs. It is also possible to map the RGB data to the LabL*a*b* data using predetermined equations and coefficients as are known to one skilled in the art.

FIGS. 7B-7D show a mapping of L*a*b* data to K data for the three portions of the L*a*b* color space shown in FIG. 7A. The mapping of FIG. 7B corresponds to the region of the L*a*b* color space where the L value is greater than 90. The mapping of FIG. 7C corresponds to the region of the L*a*b* color space where the L* value is between 45 and 50. The mapping of FIG. 7D corresponds to the region of the L*a*b color space where the L*value is between 0 and 20. In each of the mappings, particular values of a* and b* identify a corresponding K value (ranging between 0 and 255). For example, if the L* value is over 90, then the K value will be one of 0, 1, 2, and 3 depending upon the values of a* and b*. FIG. 7E shows the range of K values and how the K values correspond to the mappings of FIGS. 7B-7D. The K values range between 0 and 255 with 0 corresponding to the lightest level and 255 corresponding to the darkest level.

By mapping of the RGB data to a corresponding K value using the L*a*b* color space, the K value more accurately reflects the color differences in the colors of an original color image. For example, different shades of the same color will have sufficiently different K values such that the black and white reproduction of the shade will show the difference, i.e., the different shades of the same color in an original color image will have different shades of grey in the black and white reproduction. For example, if the range of the luminance L* is 45, as shown in FIG. 7C, and the values of a* and b* are as shown below;

Red: a*=48, b*=14

Blue: a*=7, b*=−48

Green: a*=−40, b*=30

Yellow: a*=4, b*=68

In this case, the K value corresponding to each color is as shown below.

K (red)=123

K (blue)=122

K (green)=121

K (yellow)=120

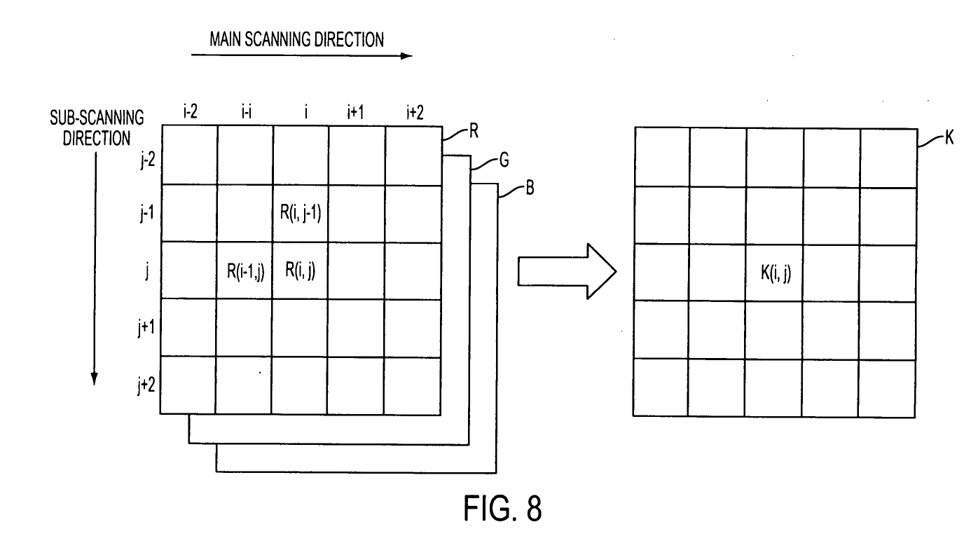

Another color conversion process for generating the K value can be used to emphasize certain characteristics of the original image. For example, the color conversion process can use the RGB data to determine K values that emphasize characters or text in the original image. FIG. 8 shows a graphical representation of another color conversion process consistent with the present invention that can be used to emphasize characters or text in the original image. As shown in FIG. 8, a selection 5×5 portion of pixels is shown for the RGB data. In addition, three pixels in the R data portion are shown: R(i,j); R(i,j−1); and R(i−1,j), where i represent a column value in the main scanning direction, and j represents a row value in the sub-scanning direction.

To determine the K value for pixel (i,j), the color conversion process calculates a difference between the pixel R(i,j) and R(i,j−1) and a difference between R(i,j) and R(i−1,j). The same calculations are made for the G data and the B data. The absolute value of each of the differences is then compared to a threshold value as shown in the following equations:

|R(i,j−1)−R(i,j)|≧Threshold;

|R(i−1,j)−R(i,j)|≧Threshold;

|G(i,j−1)−G(i,j)|≧Threshold;

|G(i−1,j)−G(i,j)|≧Threshold

|B(i,j−1)−B(i,j)|≧Threshold; and

|B(i−1,j)−B(i,j)|≧Threshold.

The threshold value can be set to, for example, 128. Of course, other threshold values may be utilized while remaining within the spirit and scope of the present invention. If each of the equations is true, then the K value for pixel (i,j) is set to 255 or the darkest value. If any of the equations are not true, then the K value for pixel (i,j) is set according to the following equation:

K(I,j)=(255−(R(i,j)+G(i,j)+B(i,j))/3)/LF

where LF is a lightening factor.
According to this formula, K (i, j) equals to the value in which the average of R (i, j), G (i, j), and B (i, j) is subtracted from 255 and divided by LF. For example, LF can be set to 2. By setting LF to a value of greater than one, the value of K(i,j) is reduced.
For example, if

R(i,j)=100

G(i,j)=100

B(i,j)=100

(R(i,j)+G(i,j)+B(i,j))/3=100,

K(i,j)=(255−100)/2=77.5

Also, for example, if

R(i,j)=64

G(i,j)=64

B(i,j)=64

(R(i,j)+G(i,j)+B(i,j))/3=64,

K(i,j)=(255−64)/2=95.5

As described above, the K value becomes a smaller value, i.e., a brighter value, than the usual processing result. The LF can be a default value set by the manufacturer or a settable value entered by a technician or a user when setting the parameters of a copy job.

By calculating the K values in this manner, characters or text in the original color image that are reproduced in black and white will be emphasized. In addition, other background color regions of the original image will be made lighter, which can reduce the amount of toner or ink used to reproduce the original image. Although the RGB pixels are compared to two adjacent pixels, one previous one in the main scanning direction and one previous one in the sub-scanning direction, it should be understood that the RGB pixels could be compared to different pixels than these. It is also possible that the RGB pixels could be compared to only one other pixel or compared to three or more pixels.

A similar color conversion process can be used to emphasize or outline the transitions between different color regions of an original color image. The same process as described above is used in which the absolute values of the differences are compared to a threshold. If all of the equations are true, then K(i,j) is again set to 255 or the darkest value. However, if any of the equations are not true, then K(i,j) is set to 0 or the lightest value. In this manner, except for the characters, text, and outlines of the transitions between color regions, the K value is set to 0. Accordingly, when reproducing an original color image as a black and white reproduction, the characters, text, and outlines of the transitions of the color regions will appear in black, and the remaining image will appear in white.

In accordance with at least one embodiment of the present invention, it is possible to use B/W image data to adjust the resolution of color image data when using a 4-line CCD in which the resolution of the B/W image data and color image data is different. In addition, the color image data in the RGB color space can be used to generate K data in the CMYK color space that accurately reflects the color differences in an original color image. As a result, if the original color image is printed in black and white, the reproduction will more clearly portray the different color regions of the original color image. The RGB data can also be used to generate K data that emphasizes the characters, text, and outlines of the transitions of the color regions of an original color image reproduced in black and white.

The following is an explanation of image information converted by a resolution and color conversion system, or a printer 60 (image forming apparatus) which outputs an image based on the image information input from an external device (not shown), and a paper P (transfer medium) or a paper feed unit 70, in accordance with an embodiment of the present invention.

The printer 60 has photoconductive drum 11 (image bearing member) that extends in a cross direction (the direction of paper), and a charging device 12, laser unit (exposure device) 13, black developing device 14, revolver 15 (developing unit), intermediate transfer belt 16 (intermediate transfer body), and drum cleaner 17 (cleaning device) are arranged along the direction of rotation of the photoconductive drum 11 (arrow direction in the drawing) around the photoconductive drum 11.

The charging device 12 charges the peripheral face 11a (hereinafter, drum surface 11a) of the photoconductive drum 11 in predetermined potential. The laser unit (exposure device) 13 is arranged near the lower limit of the printer 60, is exposed by the laser beam which scans drum surface 11a charged to the predetermined potential, and forms the electrostatic latent image in each color on the drum surface 11a.

The black developing device 14 develops an electrostatic latent image for black formed on the drum surface 11a by the laser unit (exposure device) 13 by supplying the black developer, so as to form a black developer image on the drum surface 11a. In the black developer 14, a developing roller is removably arranged to attach to and detach from the drum surface 11a. When forming a black image, the developing roller moves so as to touch the drum surface 11a, and when forming an image in other colors, the developing roller moves so as to detach from the drum surface 11a. The developer is supplied to the black developing device 14 from a toner cartridge 14a.

The revolver 15 is rotatably arranged to the photoconductive drum 11 at the left side shown in the drawing. The revolver 15 includes yellow developing device 15Y, magenta developing device 15M, and cyan developing device 15C. Each developing device includes toner cartridges 15y, 15m, and 15c which store each color of the developer respectively. When forming an image, the revolver 15 is rotated in clockwise direction, so that the predetermined developing device is selectively opposed to photoconductive-drum surface 11a.

The intermediate transfer belt 16 is arranged at the position which touches the photoconductive drum 11 from the upper part. The intermediate transfer belt 16 is wound around the driving roller 16a, pre transfer roller 16b, transfer counter rollers 16c, and tension roller 16d which have the axis of rotation extended in the front-rear direction (space direction), respectively. Inside the intermediate transfer belt, there is a primary transfer roller 21 which presses the intermediate transfer belt 16 to the drum surface 11a with a specified pressure, so that the developer image formed on the drum surface 11a is transferred to the intermediate transfer belt. On the periphery of the intermediate transfer belt 16, a belt cleaner 22 for cleaning the belt and a secondary transfer roller 24 for transferring the developer image on the belt to the paper P are arranged detachably to the belt surface.

The paper feed unit 70 includes two sheet paper cassettes 26 and 28. Pickup rollers 31 which take out paper P contained in the cassette from the uppermost edges are arranged in the right upper side of each cassettes 26 and 28, respectively, in the drawing. Feed roller 32 and separation roller 33 are arranged by touching mutually at the position adjacent to the downstream direction of the paper exit by the pickup roller 31.

At the position adjacent to the right side of the paper feed cassettes 26 and 28 in the drawing, a paper conveying path 26 which directs to the secondary transfer point at which the intermediate transfer belt 16 mentioned above and the secondary transfer roller 24 are in contact is arranged. On the paper-conveying path 26, a plurality of conveying roller pairs 34 and aligning roller pairs 36 are arranged in order.

On the paper-conveying path 26 which extends up through the secondary transfer point, a fuser unit 38 which fixes the developer transferred on the paper P by heating and pressing is arranged. The fuser unit 38 has a heating roller 38b with a heater, and a pressurizing roller 38a which is arranged by pressing to the heating roller.

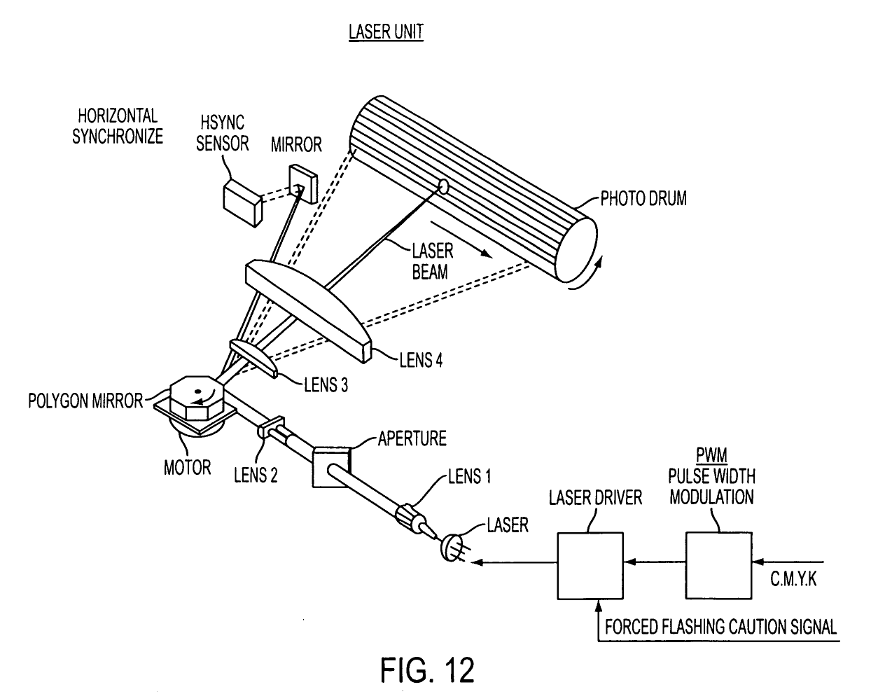

The following is an explanation of a laser unit (exposure device) 13 that can be utilized in at least one embodiment of the present invention. FIG. 12 is a drawing showing the relation between an inner part of the laser unit 13 and the photoconductive drum 11 (image bearing member). Some reflective mirrors are omitted in order to simplify that drawing. A PWM (Pulse Width Modulation) circuit and a laser drive circuit are built in the laser unit 13. The PWM circuit outputs a pulse signal according to the image information of C, M, Y, and K which are sent from the page memory 440. The laser drive circuit makes a laser diode radiate light beam according to the pulse signal which the PWM circuit outputs, and the compulsive flashing caution signal sent from the control section.

The laser beam radiated from the laser diode becomes a parallel beam at the lens 1, an excessive light is shielded at the aperture, and the parallel beam enters the polygon mirror by passing through the lens 2. The polygon mirror rotates to the direction of rotation shown in the drawing by the polygon motor at high speed, and reflects the reflected light in the direction of the lens 3. Since the polygon mirror is rotating, the reflected light from the polygon mirror is a scanning light. The light which entered into lens 3 passes lens 4, and turns into light which scans photoconductive-drum 11 (image bearing member) from the left to the right sides as shown in the drawing. A part of this scanning light is reflected by the mirror shown in the drawing, and enters into HSYNC Sensor (Horizontal Synchronize Sensor).

The light which enters into the HSYNC Sensor is the one which radiated by the compulsive flashing caution signal mentioned above. HSYNC Sensor will output a synchronizing signal, when light enters. Although details are not explained here for sake of brevity, the image information per a line unit is sent from the page memory 440 on the basis of this signal.

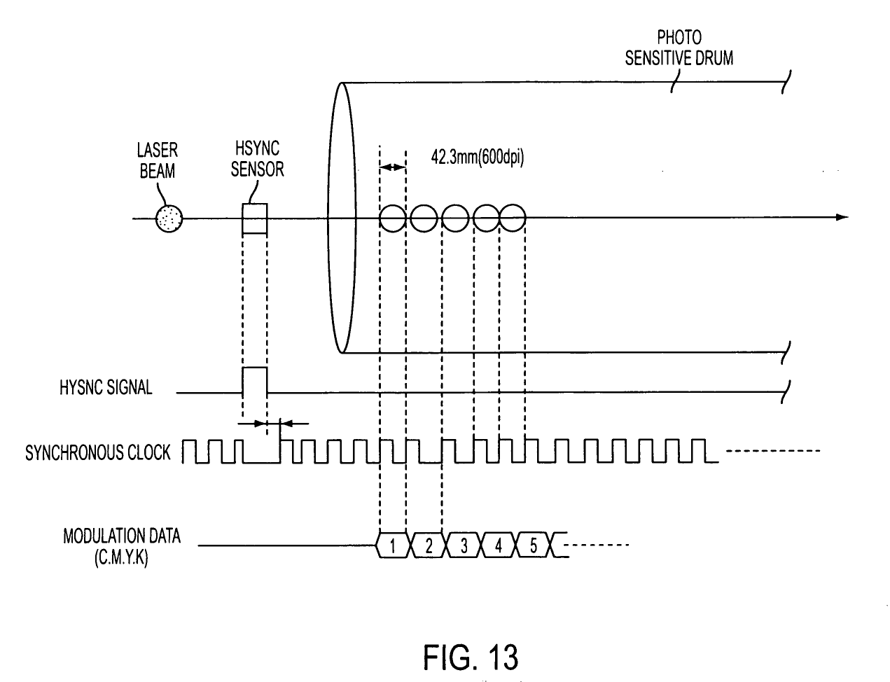

FIG. 13 is a timing chart showing the relation among the photoconductive drum 11, a HSYNC Sensor, and each signal output. The HSYNC Signal will be outputted if light enters into HSYNC Sensor. Synchronizing with the synchronous clock which synchronized with this signal, image information (modulation data) is sent from the page memory 440 per a line unit. A black image is transmitted when a monochrome image is recorded. When a color image is recorded, yellow image information is transmitted first, then magenta image information, and cyan image information, and finally black image information is transmitted.

The record pitch (the third resolution) in the main scanning direction of the electrostatic latent image recorded on the photoconductive drum 11 (image bearing member) has a close relation to the synchronous clock and the scanning speed (rotational speed of the polygon motor) of light, as exemplarily shown in the drawing. In one possible implementation of the present invention, this pitch will be the same as the MONOCHROME read resolution (600 dpi: the first resolution) of the scanning direction of the scanner part.

Similarly, the record pitch (the third resolution) of the sub scanning direction of the electrostatic latent image recorded on the photoconductive drum 11 (image bearing member) has a close relation to the rotational speed of the photoconductive drum 11, and the scanning period (rotational speed of the polygon motor) of light. In accordance with at least one embodiment of the present invention, the rotational speed of the photoconductive drum 11 and the scanning period (rotational speed of the polygon motor) of light are set up so that the MONOCHROME read resolution of the scanner part in the sub scanning direction will be the same as the main scanning direction.

Next, operations for outputting a monochrome image and color image are explained. Operations for outputting a monochrome image are as shown below. First, revolver 15 rotates to the home position where all of developing devices 15Y, 15M, and 15C do not oppose to the drum surface 11a. The black developing device 14 moves up to oppose to the drum surface 11a. The belt cleaner 22 rotates clockwise centering on the axis 22a, and contacts the intermediate transfer belt 16, and the secondary transfer roller 24 moves leftward in the drawing, and contact the intermediate transfer belt 16 while it is rotating.

Laser unit (exposure device) 13 scans a laser beam on the drum surface 11a based on the image information for blacks (B/W) transmitted from the page memory 440, or the image information for blacks (B/W) inputted from the external device (not shown). The electrostatic latent image for blacks is then formed on the drum surface 11a. Then, the black developer is supplied to the electrostatic latent image on the drum surface 11a by the black developing device 14, and the black developer image is formed on the drum surface 11a.

The black development image formed on the drum surface 11a in this way is moved by the rotation of the photoconductive drum 11 and reaches to the primary transfer point which contacts the intermediate transfer belt 16. At the primary transfer point, the black developer image on drum surface 11a is transferred on the intermediate transfer belt 16 by the pressure and potential (bias) of the primary transfer roller 21.

The black developer which remained without being transferred from the drum surface 11a after passing the primary transfer point is removed by the drum cleaner 17, and residual charge is also discharged simultaneously. The drum surface 11a is then uniformly charged by the charging device 12 for forming the electrostatic-latent-image for the next blacks. When the black-image forming is performed continuously, a series of processes, i.e., exposure→development→transferring to the intermediate transfer belt 16, as well as the previous operation, is performed.

In the meantime, the black developer image transferred on the intermediate transfer belt moves by rotation of the intermediate transfer belt 16, and passes the secondary transfer point between the belt and the secondary transfer roller 24. Once paper P picked out from the cassette 26 or 28 by the pickup roller 31 is transferred by the conveying roller pair 34 in the longitudinal conveying path 26 upwards, and once positioning is performed with aligning roller 36, the paper P is sent to the secondary transcriptional region at the predetermined timing.

The black developer on the intermediate transfer belt 16 is then transferred on the paper P by the pressure and potential (bias) of the secondary transfer roller 24. After transferring a developer on the paper P, the black developer which remained on the intermediate transfer belt 16 is removed by the belt cleaner 22.

When paper P on which the black developer is transferred passes the fuser unit 38 after this, the paper is heated and pressurized, so as to form a black image. The paper P on which the black image is formed in this way is discharged to the paper output tray 44 via the discharge roller 42 provided in the downstream of the fuser unit 38. In this manner, the black image having the predetermined resolution (=600 dpi: the third resolution) is formed on the paper P.

The operation for outputting a color image in accordance with at least one embodiment of the present invention is described below as follows. The black developing device 14 is moved downward first, and is separated from the drum surface 11a. The revolver 15 rotates clockwise and the yellow developing device 15Y opposes the drum surface 11a. The belt cleaner 22 rotates counterclockwise centering on axis 22a, and is separated from intermediate transfer belt 16, and moves in the direction that the secondary transfer roller 24 separates from the paper conveying path 26 (in the right direction in the drawing).

The laser unit (exposure device) 13 scans the laser beams on the drum surface 11a based on the image information for yellow transmitted from the page memory 440, and the electrostatic latent image for yellow is formed on the drum surface 11a. Then, the yellow developer is supplied to the electrostatic latent image on the drum surface 11a via the yellow developing device 15Y, and a yellow developer image is formed on the drum surface 11a. The yellow development image formed on the drum surface 11a in this way is moved by the rotation of the photoconductive drum 11 and reaches to the primary transfer point which contacts the intermediate transfer belt 16. At the primary transfer point, the yellow developer image on drum surface 11a is transferred on the intermediate transfer belt 16 by the pressure and potential (bias) of the primary transfer roller 21.

The yellow developer which remained without being transferred from the drum surface 11a after passing the primary transfer point is removed by the drum cleaner 17, and residual charge is also discharged simultaneously. The drum surface 11a is then uniformly charged by the charging device 12 for forming the electrostatic-latent-image for the next magenta.

The revolver 15 rotates and the magenta developing device 15M opposes to the drum surface 11a. In this situation, as same as the previous yellow operation, a series of processes, i.e., exposure→development→transferring to the intermediate transfer belt 16 is performed, and a magenta developer image is transferred by overlapping on the yellow developer image on the intermediate transfer belt 16.

In this manner, after a magenta developer image is transferred in this manner, a cyan developer image is transferred by overlapping on the magenta similarly. The revolver 15 rotates to the home position where all of developing devices 15Y, 15M, and 15C do not oppose to the drum surface 11a. The black developing device 14 goes up instead and opposes to the drum surface 11a.

In this situation, the similar processes as ones mentioned above are performed, and the black developer image is overlapped on the yellow developer image, magenta developer image, and the cyan developer image on the intermediate transfer belt 16. In this manner, if the developer image of all the colors are overlapped on the intermediate transfer belt, the secondary transfer roller 24 will move leftward in the drawing and contact the intermediate transfer belt 16, and the belt cleaner 22 will also contact the intermediate transfer belt 16. The developer image of all the colors overlapped on the intermediate transfer belt in this situation is moved by rotation of the intermediate transfer belt 16, and passes the secondary transfer point between the belt and the secondary transfer rollers 24.

Once paper P picked out from the cassette 26 or 28 by the pickup roller 31 is transferred by the conveying roller pair 34 in the longitudinal conveying path 26 upwards, and once positioning is performed with aligning roller 36, the paper P is sent to the secondary transcriptional region at the predetermined timing. The developer of each color on the intermediate transfer belt 16 is then transferred on the paper P by the pressure and potential (bias) of the secondary transfer roller 24.

After transferring a developer on the paper P, the developer which remained on the intermediate transfer belt 16 is removed by the belt cleaner 22. When paper P on which the developer of each color is transferred passes the fuser unit 38 after this, the paper is heated and pressurized, so as to form a color image. The paper P on which the color image is formed in this way is discharged to the paper output tray 150 via the discharge roller 42 provided in the downstream of the fuser unit 38. In this manner, the color image having the predetermined resolution (=600 dpi: the third resolution) is formed on the paper P.

Next, a control panel (operation element) 140 of an image forming apparatus in accordance with at least one embodiment of the present invention is described below. A control panel (operation element) 140 has keys and buttons such as, a full color copy button, regular monochrome copy button, a color identification copy button, an edge enhancement copy button, an outline copy button, an indication area, ten keys from zero to nine, a C (clear) button, a reset button, a stop button, a start button, and a copy/scanner button.

The full color copy button is a button for switching the image forming apparatus into full color copy mode. The regular monochrome copy button is a button for switching the image forming apparatus into ordinary monochrome copy mode.

The color identification copy button is a button for switching the mode of the image forming apparatus to the monochrome copy mode which outputs the color difference as the darkness difference. Various setting in this mode can be set up in detail by the touch panel of the indication area. Density settings, for example, lightening or darkening any colors, i.e., settings of changing LUT (look-up table) explained in FIG. 7 and settings of changing the image output color (toner) into ones other than black (default) are possible.

The edge enhancement copy button is a button for switching the image forming apparatus to the monochrome copy mode for emphasizing the outline as previously explained. Various setting in this mode can be set up in detail by the touch panel of the indication area. Density settings, for example, deciding the area other than the outline and the degree of density, i.e., settings of LF (lightening factor) previously explained and settings of changing the image output color (toner) into ones other than black (default), are possible.

The outline copy button switches the image forming apparatus into the mode which copies the outline only in monochrome. Although black (toner) is set up for an image output as a default in this mode, it is possible to specify the other colors (toner) by a touch panel of the indication area. The copy/scanner button is a button for selecting whether the image forming apparatus is operated as a scanner or a copier. The default is the copier.

As already stated, the indication area is a touch panel, and a user can specify the detailed operation, while the display shows the status of the image forming apparatus. For example, copying magnification, selection of paper, the color selection of a mono-color copy, etc. other than functional specification and detailed operation setting previously explained can be performed.

The buttons of 0 to 9 (ten key) are used for inputting the number of copies. The C button is a clear button and is used for clearing the inputted number-of-sheets. The reset button is used for returning all the setup conditions to initial (default) conditions with the control panel. The stop button is used for stopping copying operation, etc., on the way. The start button is used for starting copying operation and scan operation.

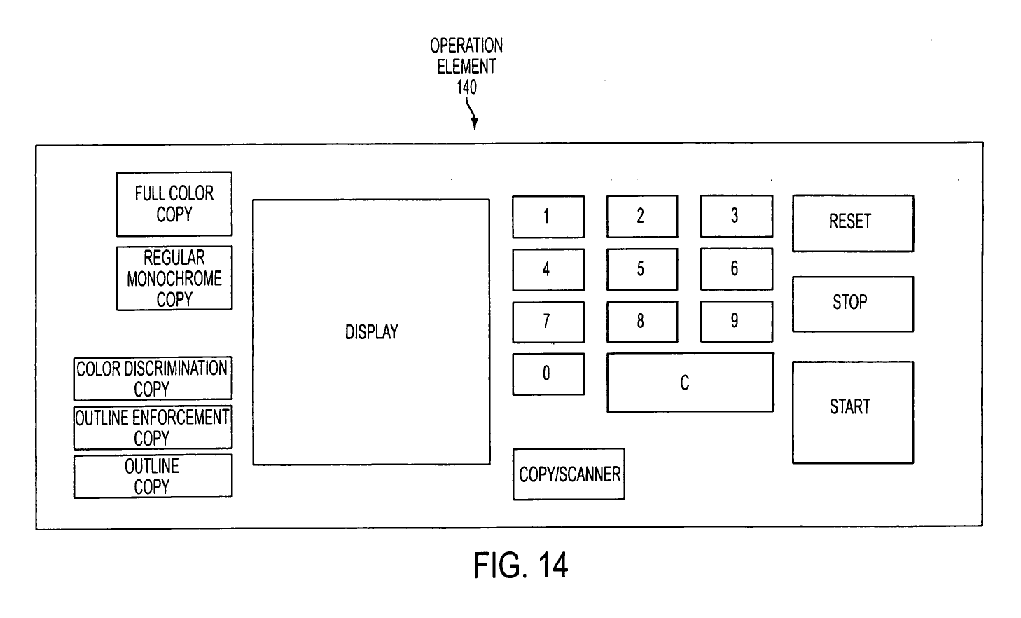

Next, the operation outline of the image forming apparatus in accordance with an embodiment of the present invention is explained below, with reference to FIG. 4 and FIG. 14 (which shows a control panel). First, operation of the image information apparatus when the full-color copy operation is specified by the full-color button on the control panel is explained. A control part issues instructions to a color-conversion part 430 to switch to the operation mode in which R, G, and B data outputted from the resolution conversion part 420 (600 dpi) is converted into Y, M, C, and K data (600 dpi). The transform processing used in this case is the general transform processing (Standard conversion).

If the paper size, copying number of sheets, etc. is set and the start button is pressed in this status, the information will be transmitted to the control part. For example, when copying an original placed on the original-table glass 220, the control part specifies the start of a predetermined operation, such as lighting of a lighting lamp 280 (white Lamp), moving of the first carriage 52 and the second carriage 55 etc., and starts reading operation of the original. The control part specifies the printer to start the color image output operation explained in previous color-image-forming operation. The scanner and the printer are started in this way.

At a scanner, an original is read by the CCD sensors, and the monochrome output (B/W1 output and B/W2 output) of the first resolution, and R, G and B output of the second resolution are outputted to the A/D converter 410.

The monochrome output of the first resolution and R, G and B output of the second resolution are converted into the B/W1 original and B/W2 original of the first resolution and R, G and B original of the second resolution (digital data) by the A/D converter 410, and inputted to the resolution conversion part 420.

The B/W1 original and B/W2 original of the first resolution, and R, G, and B original of the second resolution which are inputted into resolution conversion part 420 are changed into R, G, and B data of the third resolution, and are inputted into the color signal conversion part 430 of the next step. The first resolution and third resolution are the same here.

R, G, and B data of the third resolution inputted into the color signal conversion part 430 is converted into C, M, Y, and K data of the third resolution so that the printer can form a full color image, and then outputted to a page memory 440. C, M, Y, and K data of the third resolution inputted to the page memory 440 is read out synchronously with the printer operation, and the full color image with the third resolution is formed on the paper.

Next, the operation of the image forming apparatus in accordance with an embodiment of the present invention when the regular monochrome copy button of the control panel is pressed, and monochrome copy operation is specified, is explained below.

The control part issues instructions to the color conversion part 430 to switch to the operation mode so as to convert the R, G, and B data (600 dpi) outputted from the resolution conversion part 420 into K data (600 dpi).

The transform processing used in this case is a processing which extracts a brightness component from RGB data, and the data will be the almost same as ones compounded the first B/W1 original and B/W2 original of the first resolution.

If the paper size, copying number of sheets, etc. is set and the start button is pressed in this status, the information will be transmitted to the control part. For example, when copying an original placed on the original-table glass 220, the control part specifies the start of a predetermined operation, such as lighting of a lighting lamp 280 (white Lamp), moving of the first carriage 52 and the second carriage 55 etc., and starts reading operation of the original. The control part specifies the printer to start the monochrome image output operation explained in previous monochrome-image-forming operation. The scanner and the printer are started in this way.

At a scanner, an original is read by the CCD sensors, and the monochrome output (B/W1 output and B/W2 output) of the first resolution, and R, G and B output of the second resolution are outputted to the A/D converter 410. The monochrome output of the first resolution and R, G and B output of the second resolution are converted into the B/W1 original and B/W2 original of the first resolution and R, G and B original of the second resolution (digital data) by the A/D converter 410, and inputted to the resolution conversion part 420.

The B/W1 original and B/W2 original of the first resolution, and R, G, and B original of the second resolution which are inputted into the resolution conversion part 420 are converted into R, G, and B data of the third resolution, and are inputted into the color signal conversion part 430 of the next step. The first resolution and third resolution are the same in this instance.

In color-conversion part 430, R, G, and B data (600 dpi) which is outputted from the resolution converter 420 is converted into K data (600 dpi), and is outputted to the page memory. The K data of the third resolution inputted to the page memory 440 is read out synchronously with the printer operation, and the monochrome image with the third resolution (600 dpi) is formed on the paper.

Here, the case where a monochrome image is formed is explained. However, when the monochrome print in other colors is specified with the control panel, the operation is performed according to it. That is, the control part specifies the conversion operation to the other colors to the color-conversion part 430, the data according to this is transmitted to the page memory 440, the printer also reads data from the page memory 440 by the operation according to this, and the image of the third resolution is formed by the specified color.

Next, the color identification copy button of the control panel is pressed, and operation of the image forming apparatus when color identification copy operation is specified is explained. The control part issues an instruction to the color-conversion part 430 to convert the color difference into the darkness difference.

If the paper size, copying number of sheets, etc., is set and the start button is pressed in this status, the information will be transmitted to the control part. For example, when copying an original placed on the original-table glass 220, the control part specifies the scanner for the start of a predetermined operation, such as lighting of a lighting lamp 280 (white Lamp), moving of the first carriage 52 and the second carriage 55 etc., and starts reading operation of the original. The control part specifies the printer to start the monochrome image output operation explained in previous monochrome-image-forming operation. The scanner and the printer are started in this way.

At a scanner, an original is read by the CCD sensors, and the monochrome output (B/W1 output and B/W2 output) of the first resolution, and R, G and B output of the second resolution are outputted to the A/D converter 410.

The monochrome output of the first resolution and R, G and B output of the second resolution are converted into the B/W1 original and B/W2 original of the first resolution and R, G and B original of the second resolution (digital data) by the A/D converter 410, and inputted to the resolution conversion part 420.

The B/W1 original and B/W2 original of the first resolution, and R, G, and B original of the second resolution which are inputted into the resolution conversion part 420 are converted into R, G, and B data of the third resolution, and are inputted into the color signal conversion part 430 of the next step. The first resolution and third resolution are the same here.

In color-conversion part 430, R, G, and B data (600 dpi) which is outputted from the resolution converter 420 is converted into K data (600 dpi), and is outputted to the page memory. The K data of the third resolution inputted to the page memory 440 is read out synchronously with the printer operation, and the monochrome image with the third resolution (600 dpi) is formed on the paper.

Here, the case where a monochrome image is formed is explained. However, when the monochrome print in other colors is specified with the control panel, the operation is performed according to it. That is, the control part specifies the conversion operation to the other colors to the color-conversion part 430, the data according to this is transmitted to the page memory 440, the printer also reads data from the page memory 440 by the operation according to this, and the image of the third resolution is formed by the specified color.

Similarly, when the edge enhancement copy operation is specified by the control panel, the control part issues instructions to the color conversion part 430 to convert R, G, and B data (600 dpi) into the previously explained data which emphasizes the outline.

The following operation is the same as the previous color identification copy operation. The edge enhancement copy operation will be possible by just changing the setting to the color-conversion part 430. Operation of the image forming apparatus when the edge enhancement copy operation is specified by the control panel is the same as that of the above.

The control part issues instructions to the color-conversion part 430 to convert R, G, and B data of the third resolution (600 dpi) to the previously explained data which emphasizes the outline. The following operation is the same as previous color identification copy operation. The outline copy operation is made possible by just changing the setting to the color-conversion part 430.

The foregoing description of a preferred embodiment of the invention has been presented for purposes of illustration and description. It is not intended to be exhaustive or to limit the invention to the precise form disclosed, and modifications and variations are possible in light in the above teachings or may be acquired from practice of the invention. The embodiment was chosen and described in order to explain the principles of the invention and as practical application to enable one skilled in the art to utilize the invention in various embodiments and with various modifications are suited to the particular use contemplated. It is intended that the scope of the invention be defined by the claims appended hereto and their equivalents.

What is claimed is:

1. An image forming apparatus comprising:
first reading means for reading an original with a first resolution,
second reading means for reading the original with a second resolution which is different from said first resolution,
conversion means for converting the image information read by said first reading means, and the image information read by said second reading means into the image information of a third resolution for image forming, and
image forming means for forming an image with the third resolution based on the image information converted by said conversion means.

2. The image forming apparatus of claim 1, wherein said first resolution is higher than said second resolution.

3. The image forming apparatus of claim 1, wherein said first resolution and said third resolution are the same.

4. The image forming apparatus of claim 1, wherein said first reading means has a sensitivity in a larger wavelength area than said second reading means.

5. The image forming apparatus of claim 1, wherein said second reading means comprises a plurality of reading elements having a sensitivity in a different wavelength area (R, G, B) respectively.

6. The image forming apparatus of claim 1, wherein said first and second reading means are integrally formed, and wherein each of said first and second reading means reads an original at the same speed.

7. An image forming apparatus comprising:
a first reading unit configured to read an original with a first resolution,
a second reading unit configured to read an original with a second resolution which is different from said first resolution,
a conversion unit configured to convert the image information read by said first reading unit, and the image information read by said second reading unit into the image information of a third resolution for image forming, and
an image forming unit configured to form an image with the third resolution based on the image information converted by said conversion unit.

8. The image forming apparatus of claim 7, wherein said first resolution is higher than said second resolution.

9. The image forming apparatus of claim 7, wherein said first resolution and said third resolution are the same.

10. The image forming apparatus of claim 7, wherein said first reading unit has a sensitivity in a larger wavelength area than said second reading unit.

11. A method of forming an image, comprising:
reading an original with a first resolution,
reading an original with a second resolution which is different from said first resolution,
converting the image information read by said first reading step, and the image information read by said second reading step into the image information of a third resolution for image forming, and
forming an image with the third resolution based on the image information converted by said converting step.

12. The method claim 11, wherein said first resolution is higher than said second resolution.

13. The method of claim 11, wherein said first resolution and said third resolution are the same.

14. The method claim 11, wherein said first reading step performs reading using a sensitivity in a larger wavelength area than said second reading step.

15. An image forming apparatus comprising:
first reading means for reading brightness information of an original;
second reading means for reading color information of the original;
conversion means for converting the brightness information read by said first reading means and the color information read by said second reading means into density information for image forming; and
image forming means for forming an image based on the density information which is converted by said conversion means.

16. The image forming apparatus of claim 15, wherein said conversion means converts the color difference into a darkness difference.

17. The image forming apparatus of claim 15, wherein said conversion means changes a change point of a color into a larger density.

18. The image forming apparatus of claim 15, wherein a read resolution of said first reading means is higher than a read resolution of said second reading means.

19. The image forming apparatus of claim 15, wherein the read resolution of said first reading means, the density image information which is converted by said conversion means, and the image-forming resolution of said image forming means are the same.

20. The image forming apparatus of claim 15, wherein said first and second reading means are integrally formed, and wherein each of said first and second reading means reads an original at the same speed.

21. The image forming apparatus of claim 15, further comprising:
specifying means for specifying one or more colors of an image formed by said image forming apparatus,
wherein said specifying means forms the image with the specified one or more colors.

22. An image forming apparatus comprising:
a first reading unit configured to read brightness information of an original;
a second reading unit configured to read color information of the original;
a conversion unit configured to convert the brightness information read by said first reading unit and the color information read by said second reading unit into density information for image forming; and
an image forming unit configured to form an image based on the density information which is converted by said conversion unit.

23. The image forming apparatus of claim 22, wherein said conversion unit converts the color difference into a darkness difference.

24. The image forming apparatus of claim 22, wherein said conversion unit changes a change point of a color into a larger density.

25. The image forming apparatus of claim 22, wherein a read resolution of said first reading unit is higher than a read resolution of said second reading unit.

26. The image forming apparatus of claim 22, wherein the read resolution of said first reading unit, the density image information which is converted by said conversion unit, and the image-forming resolution of said image forming unit are the same.

27. The image forming apparatus of claim 15, wherein said first and second reading unit are integrally formed, and wherein each of said first and second reading unit reads an original at the same speed.

28. The image forming apparatus of claim 15, further comprising:
a specifying unit configured to specify one or more colors of an image formed by said image forming apparatus,
wherein said specifying unit forms the image with the specified one or more colors.

29. A method of forming an image, comprising:
reading brightness information of an original;
reading color information of the original;
converting the brightness information read by said first reading step and the color information read by said second reading step into density information for image forming; and
forming an image based on the density information which is converted by said converting step.

30. The method of claim 29, wherein said converting step converts the color difference into a darkness difference.

31. The method of claim 29, wherein said converting step changes a change point of a color into a larger density.

32. An image forming apparatus comprising:
first reading means for reading brightness information of an original;
second reading means for reading color information of the original;
conversion means for converting the brightness information read by said first reading means and the color information read by said second reading means into density information for the image forming; and
image forming means for forming an image based on the color information which is converted by said conversion means.

33. The image forming apparatus of claim 32, wherein a resolution of said first reading means is higher than a resolution of said second reading means.

34. The image forming apparatus of claim 32, wherein a resolution of said first reading means and a resolution of the image which is formed by said image forming means are the same.

35. The image forming apparatus of claim 32, wherein said first and second reading means are integrally formed, and wherein each of said first and second reading means reads an original at the same speed.

36. A method of forming an image, comprising:
reading brightness information of an original;
reading color information of the original;
converting the brightness information read by said first reading step and the color information read by said second reading step into density information for the image forming; and
forming an image based on the color information which is converted by said converting step.

37. The method of claim 36, wherein a resolution of said first reading step is higher than a resolution of said second reading step.

38. The method of claim 36, wherein a resolution of said first reading step and a resolution of the image which is formed by said forming step are the same.

39. The method of claim 36, wherein each of said first and second reading steps reads an original at the same speed.

40. An image forming apparatus comprising:
first reading means for reading brightness information of an original;
second reading means for reading color information of the original;
conversion means for converting the brightness information read by said first reading means and the color information read by said second reading means into density information or color image information for forming an image;
image forming means for forming a monochrome image or a color image based on the density information or color image information converted by said conversion means, and
specifying means for specifying whether to copy an original in one color or copy in multiple colors,
wherein the image forming apparatus copies an original in monochrome or multiple colors according to information provided by said specifying means.

41. The image forming apparatus of claim 40, wherein a resolution of said first reading means is higher than a resolution of said second reading means.

42. The image forming apparatus of claim 40, wherein a resolution of said first reading means and a resolution of the image which is formed by said image forming means are the same.

43. The image forming apparatus of claim 40, wherein said first and second reading means are integrally formed, and wherein each of said first and second reading means reads an original at the same speed.

44. A method of forming an image, comprising:
reading brightness information of an original;
reading color information of the original;
converting the brightness information read by said first reading step and the color information read by said second reading step into density information or color image information for forming an image;
forming a monochrome image or a color image based on the density information or color image information converted by said converting step, and
specifying whether to copy an original in one color or copy in multiple colors,
wherein the image forming apparatus copies an original in monochrome or multiple colors according to information provided by said specifying step.

45. The method of claim 44, wherein a resolution of said first reading step is higher than a resolution of said second reading step.

46. The method of claim 44, wherein a resolution of said first reading step and a resolution of the image which is formed by said image forming step are the same.

47. The method of claim 44, wherein each of said first and second reading steps reads an original at the same speed.
